(19) United States
(12) Patent Application Publication
(10) Pub. No.: US 2026/0079557 A1
(43) Pub. Date: Mar. 19, 2026

(54) ELECTRICAL APPLIANCE MONITORING SYSTEM AND ELECTRICAL APPLIANCE MONITORING METHOD

(71) Applicant: INSTITUTE FOR INFORMATION INDUSTRY, TAIPEI CITY (TW)

(72) Inventors: Han Li, Taipei (TW); YUNG-CHIEH HUNG, Taipei (TW); KUEI-CHUN CHIANG, Taipei (TW)

(21) Appl. No.: 18/936,997

(22) Filed: Nov. 4, 2024

(30) Foreign Application Priority Data
Sep. 13, 2024 (TW) 113134759

(51) Int. Cl. G06F 1/3234

(52) U.S. Cl. CPC G06F 1/3234

(57) ABSTRACT

An electrical appliance monitoring system and an electrical appliance monitoring method are provided. The electrical appliance monitoring system comprises a processor and a storage circuit. The processor is electrically connected to the storage circuit. The storage circuit stores a power consumption data model and on-off state identification models. The processor executes the power consumption data model to output power timing records according to the total power timing data. The processor extracts characteristic waveforms from the power consumption data model. The processor executes the on-off state identification models. Each on-off state identification model outputs the on-off state identification timing records according to the characteristic waveforms. The processor outputs on-off state timing data for each electrical appliance according to the on-off state identification timing records outputted by the on-off state identification models. The processor generates the on-off states corresponding to each electrical appliance according to the on-off state timing data.

### CROSS-REFERENCE TO RELATED PATENT APPLICATION

This application claims the benefit of priority to Taiwan Patent Application No. 113134759, filed on Sep. 13, 2024. The entire content of the above identified application is incorporated herein by reference.

Some references, which may comprise patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a load monitoring device and a monitoring method, particularly to a non-intrusive load monitoring device and a monitoring method.

### BACKGROUND OF THE DISCLOSURE

With the advancement of technology, various electrical appliances are widely applied in households. In order to achieve energy-saving goals, load monitoring devices that monitor the usage status of electrical appliances have been developed.

Generally, load monitoring devices can be classified into intrusive load monitoring devices and non-intrusive load monitoring devices. Intrusive load monitoring devices require the installation of sensors on each electrical appliance to detect the usage status of each appliance. Non-intrusive load monitoring devices, on the other hand, only need sensors installed at the main power switch to determine the usage status of each electrical appliance by analyzing changes in the total voltage and total current at the main power switch. Therefore, compared to intrusive load monitoring devices, non-intrusive load monitoring devices have lower hardware costs.

However, existing non-intrusive load monitoring devices still face some challenges. For example, non-intrusive load monitoring devices rely on high sampling frequencies to extract the characteristic values of each electrical appliance. Additionally, non-intrusive load monitoring devices need to collect new data to build models for different environments, which may lead to overfitting issues. Moreover, non-intrusive load monitoring devices have higher error rates in identifying the usage status of low-energy appliances.

### SUMMARY OF THE DISCLOSURE

The technical problem to be solved by the present disclosure is to provide an electrical appliance monitoring system and an electrical appliance monitoring method that address the deficiencies of existing technology.

To solve the aforementioned technical problem, one technical solution provided by the present disclosure is an electrical appliance monitoring system, comprising: a processor; and a storage circuit, electrically connected to the processor and configured to store a power consumption data model and a plurality of on-off state identification models; wherein the processor is configured to access the storage circuit to perform the following steps: executing the power consumption data model to output a plurality of power timing records according to a total power timing data, wherein the plurality of power timing records respectively correspond to a plurality of electrical appliances; extracting a plurality of characteristic waveforms from the power consumption data model; executing the plurality of on-off state identification models, wherein each of the on-off state identification models is configured to output a plurality of on-off state identification timing records according to the plurality of characteristic waveforms, and the plurality of on-off state identification timing records respectively correspond to the plurality of electrical appliances; generating an on-off state timing record for each electrical appliance according to the plurality of on-off state identification models; and generating a plurality of on-off states corresponding to each electrical appliance according to the on-off state timing records.

To solve the aforementioned technical problem, another technical solution provided by the present disclosure is an electrical appliance monitoring method, comprising: accessing a storage circuit via a processor to perform the following steps: executing the power consumption data model to output a plurality of power timing records according to a total power timing data, wherein the plurality of power timing records respectively correspond to a plurality of electrical appliances; extracting a plurality of characteristic waveforms from the power consumption data model; executing the plurality of on-off state identification models, wherein each of the on-off state identification models is configured to output a plurality of on-off state identification timing records according to the plurality of characteristic waveforms, and the plurality of on-off state identification timing records respectively correspond to the plurality of electrical appliances; generating an on-off state timing record for each electrical appliance according to the plurality of on-off state identification models; and generating a plurality of on-off states corresponding to each electrical appliance according to the on-off state timing records.

One of the advantageous effects of the present disclosure is that the electrical appliance monitoring system and the electrical appliance monitoring method utilize transfer learning technology to extract characteristic values of electrical appliances at a low sampling rate while effectively reducing the error rate of identifying the on-off states of low-energy appliances. By using ensemble learning with the plurality of on-off state identification models, the system not only achieves higher tolerance in complex environments but also improves the accuracy of identifying the on-off states of electrical appliances.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of the electrical appliance monitoring system according to an embodiment of the present disclosure.

FIG. 2 is a flowchart of the electrical appliance monitoring method according to an embodiment of the present disclosure.

FIG. 3 is a flowchart of a training method for the power consumption data model according to an embodiment of the present disclosure.

FIG. 4 is a schematic diagram of an embodiment where the processor extracts a plurality of characteristic waveforms from the power consumption data model according to an embodiment of the present disclosure.

FIG. 5 is a flowchart of a training method for the on-off state identification model according to an embodiment of the present disclosure.

FIG. 6 is a performance evaluation data table for the electrical appliance monitoring method provided by the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” comprises plural reference, and the meaning of “in” comprises “in” and “on. ” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether or not a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, messages or the like, which are for distinguishing one component/message from another one only, and are not intended to, nor should be construed to impose any substantive limitations on the components, messages or the like.

The following describes the embodiments of the present disclosure concerning “the electrical appliance monitoring system and the electrical appliance monitoring method” through specific embodiments. Those skilled in the art can understand the advantages and effects of the present disclosure from the content disclosed in this specification. The present disclosure can be implemented or applied through other different specific embodiments, and the details in this specification can also be modified and changed in various ways based on different perspectives and applications without departing from the spirit of the present disclosure. Additionally, the figures of the present disclosure are merely simple schematic illustrations and are not drawn to actual scale, as declared in advance. The following embodiments will further describe the relevant technical content of the present disclosure in more detail, but the disclosed content is not intended to limit the scope of protection of the present disclosure.

It should be understood that although the terms “first,” “second,” “third,” etc. may be used herein to describe various components or signals, these components or signals should not be limited by these terms. These terms are primarily used to distinguish one component from another or one signal from another. Additionally, the term “or” used herein should be interpreted to comprise any or all combinations of the associated listed items, as appropriate depending on the context.

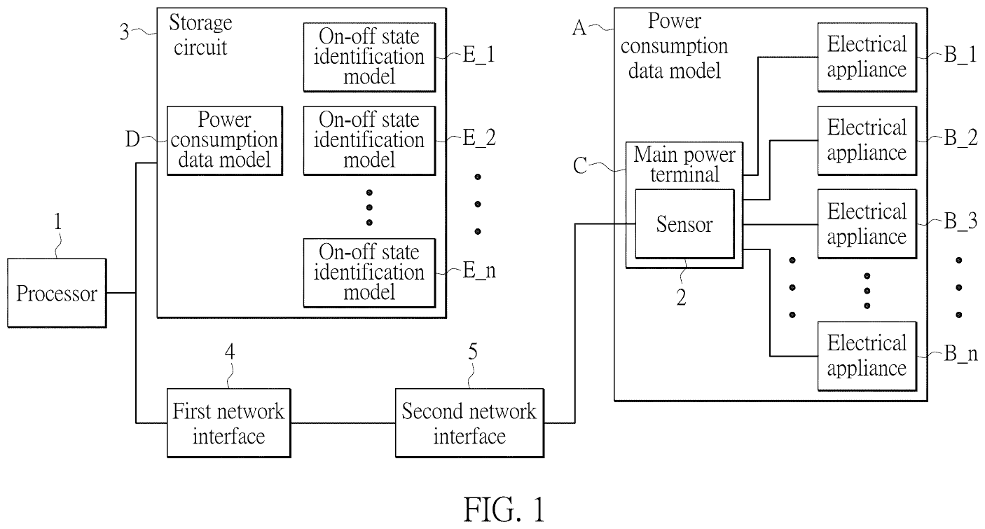

FIG. 1 illustrates a schematic diagram of the electrical appliance monitoring system according to an embodiment of the present disclosure. Referring to FIG. 1, a plurality of electrical appliances B_1˜B_n are installed in a house A, and an electrical appliance monitoring system is used to monitor the on-off states of the plurality of electrical appliances B_1˜B_n. The electrical appliance monitoring system comprises a processor 1, a sensor 2, a storage circuit 3, a first network interface 4, and a second network interface 5. The processor 1 can be, for example, one or a combination of a central processing unit (CPU), digital signal processor (DSP), embedded controller, application-specific integrated circuit (ASIC), field-programmable gate array (FPGA), microprocessor, or microcontroller, and the processor 1 is electrically connected to the storage circuit 3 and the first network interface 4.

The sensor 2 is installed at a main power supply terminal C of the house A. The main power supply terminal C is connected to the plurality of electrical appliances B_1˜B_n and the sensor 2 is configured to collect total power timing data from the main power supply terminal C during a predetermined sampling period.

For example, electrical appliances B_1˜B_3 are installed in the house A, and the main power supply terminal C is coupled to the appliances B_1˜B_3. During a day, the sensor 2 obtains total power timing data from the main power supply terminal C based on a preset sampling frequency. The total power timing data comprises a plurality of total power consumption values at different time points, and each total power consumption value corresponds to the total power consumption of the electrical appliances B_1˜B_3.

The first network interface 4 is network-connected to the second network interface 5, and the sensor 2 is electrically connected to the second network interface 5. The sensor 2 transmits the total power timing data to the processor 1 via the second network interface 5. However, this is merely an example, and the present disclosure is not limited thereto. The processor 1 may also be directly connected to the sensor 2 and directly obtain the total power timing data without through any network interface.

The storage circuit 3 can be, for example, one or a combination of programmable read-only memory (PROM), erasable programmable read-only memory (EPROM), and flash memory. The storage circuit 3 stores a power consumption data model D. The processor 1 is configured to access the storage circuit 3 to execute the power consumption data model D.

Specifically, the total power timing data is the input data for the power consumption data model D, and the power consumption data model D outputs a plurality of power timing records based on the total power timing data. The plurality of power timing records correspond to the plurality of electrical appliances B_1˜B_n, respectively. In brief, the power consumption data model D is trained to predict the actual power consumption of each electrical appliance in a specific environment (e.g., the power consumed during a specific time interval) based on the total power timing data.

The storage circuit 3 also stores a plurality of different on-off state identification models E_1E_n. Each on-off state identification model is configured to output a plurality of on-off state identification timing records based on a plurality of characteristic waveforms from the power consumption data model D, and the plurality of on-off state identification timing records correspond to the plurality of electrical appliances B_1˜B_n, respectively.

Specifically, the power consumption data model D generates the plurality of characteristic waveforms based on the total power timing data. The plurality of characteristic waveforms serve as input data for each on-off state identification model, and each on-off state identification model outputs the plurality of on-off state identification timing records based on the plurality of characteristic waveforms. The plurality of on-off state identification timing records correspond to the plurality of electrical appliances B_1˜B_n, respectively.

The processor 1 is configured to generate on-off state timing data for each electrical appliance based on the plurality of on-off state identification timing records output by the plurality of on-off state identification models. Each on-off state identification timing record comprises a plurality of on-off identification results and a plurality of time points corresponding thereto. The processor 1 is further configured to generate the plurality of on-off states corresponding to each electrical appliance based on the on-off state timing data. Specifically, the processor 1 uses a majority voting method to filter the majority on-off state identification timing records for each electrical appliance as the on-off state timing records.

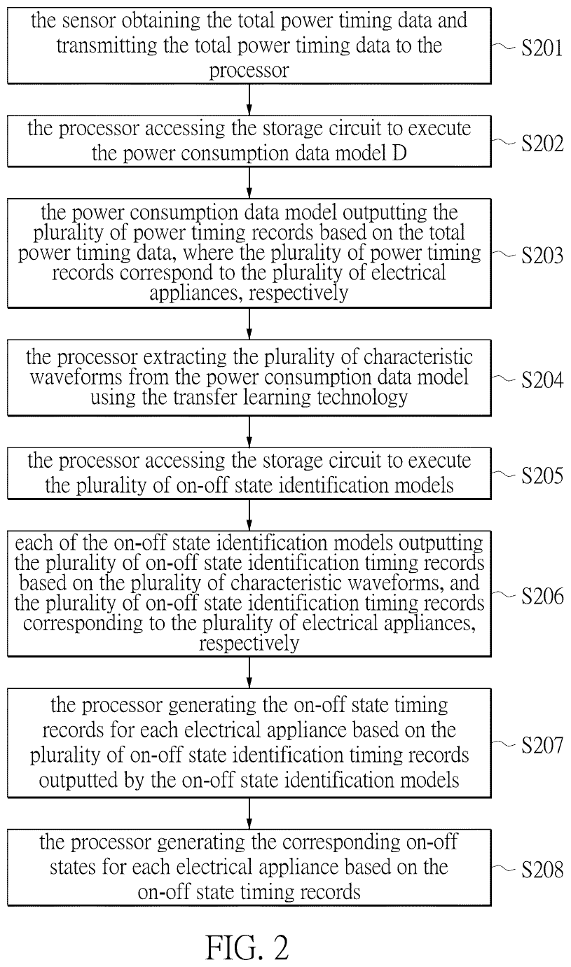

FIG. 2 illustrates a flowchart of the electrical appliance monitoring method according to an embodiment of the present disclosure, which can be applied to the electrical appliance monitoring system shown in FIG. 1.

In S201, the sensor 2 obtains the total power timing data and transmits the total power timing data to the processor 1.

In S202, the processor 1 accesses the storage circuit 3 to execute the power consumption data model D.

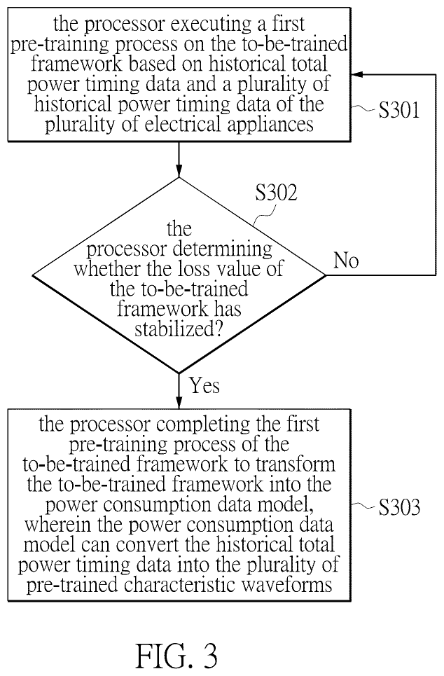

The power consumption data model D is a machine learning model that has been trained. FIG. 3 illustrates the training method of the power consumption data model D according to an embodiment of the present disclosure.

Referring to FIG. 3, in S301, the processor 1 executes a first pre-training process on the to-be-trained framework based on historical total power timing data and a plurality of historical power timing data of the plurality of electrical appliances B_1˜B_n.

Specifically, the historical total power timing data comprises a plurality of historical total power consumption values and a plurality of time points corresponding thereto, where each historical total power consumption value is the historical total power consumption of the plurality of electrical appliances B_1˜B_n. The historical power timing data for each electrical appliance comprises the plurality of historical power consumption values and the plurality of time points corresponding thereto, where each historical power consumption value is the historical power consumption of each electrical appliance.

The historical total power timing data is used as the input data for the to-be-trained framework, while a plurality of historical power timing data serves as the reference answers. The processor 1 calculates the loss value between the output data of the to-be-trained framework and the reference answers and adjusts one or more parameter values of the to-be-trained framework based on the loss value.

In S302, the processor 1 determines whether the loss value of the to-be-trained framework has stabilized. If yes, the step proceeds to S303. If no, the step returns to S301. In S303, the processor 1 completes the first pre-training process of the to-be-trained framework to transform the to-be-trained framework into the power consumption data model D, in which the power consumption data model can convert the historical total power timing data into the plurality of pre-trained characteristic waveforms.

Returning to FIG. 2, in S203, the power consumption data model D outputs the plurality of power timing records based on the total power timing data, where the plurality of power timing records correspond to the plurality of electrical appliances B_1˜B_n, respectively.

For example, the power consumption data model D is a convolutional neural network model. When the processor 1 inputs the total power timing data into the convolutional neural network model, the model outputs the first power timing data, the second power timing data, and the third power timing data. The first power timing data comprises a plurality of power consumption values of electrical appliance B_1 and a plurality of time points corresponding thereto, the second power timing data comprises a plurality of power consumption values of electrical appliance B_2 and a plurality of time points corresponding thereto, and the third power timing data comprises a plurality of power consumption values of electrical appliance B_3 and a plurality of time points corresponding thereto.

In S204, the processor 1 extracts the plurality of characteristic waveforms from the power consumption data model D using the transfer learning technology.

Specifically, the processor 1 inputs the total power timing data F into the power consumption data model D. The power consumption data model D first performs feature extraction on the total power timing data to obtain a plurality of feature factors that are correlated with the total power timing data (for example, daily total power consumption). Based on the plurality of feature factors, the total power timing data is transformed into the plurality of characteristic waveforms. Then, the power consumption data model D further converts the plurality of characteristic waveforms into the plurality of power timing records. Each characteristic waveform contains a plurality of characteristic values and a plurality of time points corresponding thereto. In other words, in addition to the total power timing data affecting the power timing records of each electrical appliance, the characteristic waveforms also influence the power timing records of each electrical appliance.

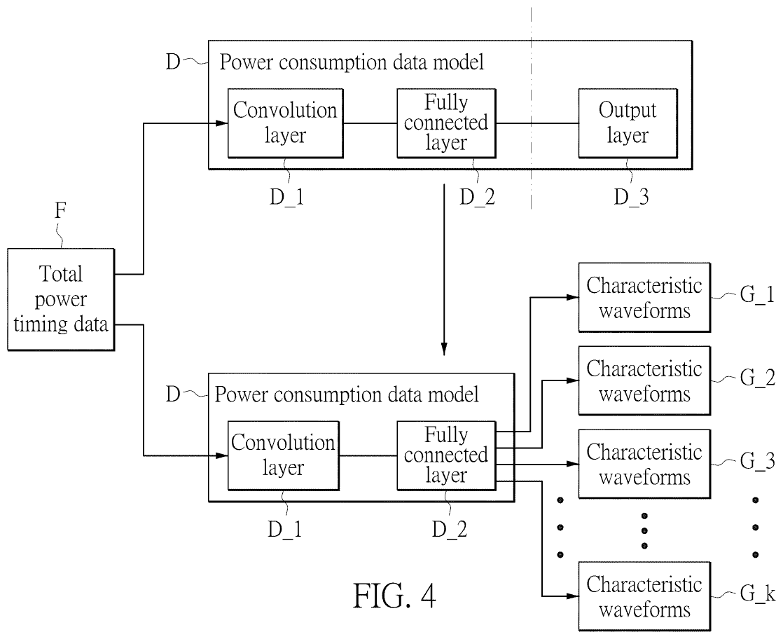

FIG. 4 illustrates an embodiment of a method for the processor to extract the plurality of characteristic waveforms from the power consumption data model D, according to the present disclosure. As shown in FIG. 4, the power consumption data model D is, for example, a convolutional neural network model, which comprises a convolution layer D_1, a fully connected layer D_2, and an output layer D_3. First, the processor 1 inputs the total power timing data F into the convolution layer D_1. Then, through convolution and pooling algorithms, the convolution layer D_1 converts the total power timing data F into a plurality of characteristic waveforms G_1˜G_k. Finally, the processor 1 removes the output layer D_3 of the convolutional neural network model and uses the fully connected layer D_2 to output the plurality of characteristic waveforms G_1˜G_k.

In other words, a number of characteristic waveforms G_1G_k is related to a number of neurons in the fully connected layer D_2. For example, if the fully connected layer D_2 has 100 neurons, the convolution layer D_1 converts the total power timing data F into 100 characteristic waveforms G_1˜G_100.

By using the aforementioned transfer learning technology, not only is it possible to extract the characteristic values of each electrical appliance at a low sampling rate, but it also effectively reduces the error rate in identifying the on-off states of low-energy-consuming electrical appliances.

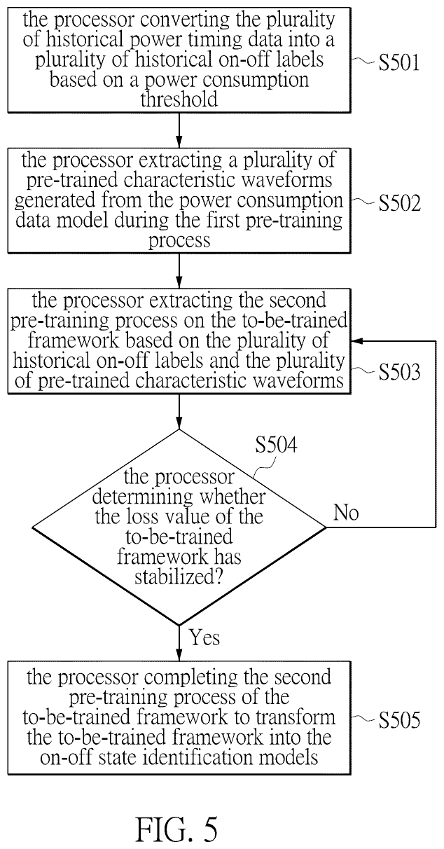

In S205, the processor 1 accesses the storage circuit 3 to execute the plurality of on-off state identification models E_1˜E_n. Each on-off state identification model is a trained machine learning model. FIG. 5 illustrates a training method for the on-off state identification models according to an embodiment of the present disclosure.

Referring to FIG. 5, in S501, the processor 1 converts the plurality of historical power timing data into a plurality of historical on-off labels based on a power consumption threshold. The plurality of historical on-off labels correspond to the plurality of electrical appliances B_1˜B_n, respectively. Each historical on-off label comprises a plurality of historical on-off status data and a plurality of time points corresponding thereto. For example, when the historical power consumption of electrical appliance B_1 exceeds the power consumption threshold, the historical on-off status data for electrical appliance B_1 indicates the “on” state. When the historical power consumption of electrical appliance B_1 is less than or equal to the power consumption threshold, the historical on-off status data indicates the “off” state.

In S502, the processor 1 extracts a plurality of pre-trained characteristic waveforms generated from the power consumption data model D during the first pre-training process.

In S503, the processor 1 executes the second pre-training process on the to-be-trained framework based on the plurality of historical on-off labels and the plurality of pre-trained characteristic waveforms. Specifically, the combination of the plurality of historical on-off labels and the plurality of pre-trained characteristic waveforms forms a feature set, and the feature set is divided into a training dataset and a testing dataset based on a preset ratio. The training dataset is used to train the to-be-trained framework, while the testing dataset is used to test the on-off state identification models.

The plurality of pre-trained characteristic waveforms are used as the input data for the to-be-trained framework, while the plurality of historical on-off labels serve as the reference answers. The processor 1 calculates the loss value between the output data of the to-be-trained framework and the reference answers and adjusts one or more parameter values of the to-be-trained framework based on the loss value.

In S504, the processor 1 determines whether the loss value of the to-be-trained framework has stabilized. If yes, the step proceeds to S505. If no, the step returns to S503. In S505, the processor 1 completes the second pre-training process of the to-be-trained framework to transform the to-be-trained framework into the on-off state identification models.

In S206, each of the on-off state identification models outputs the plurality of on-off state identification timing records based on the plurality of characteristic waveforms, and the plurality of on-off state identification timing records correspond to the plurality of electrical appliances B_1˜B_n, respectively.

For example, the storage circuit 3 stores the on-off state identification models E_1˜E_3, which may be, for instance, a random forest model, an extreme gradient boosting model, and an adaptive boosting model, respectively. However, the on-off state identification models used in the present disclosure are not limited to the aforementioned types of models.

The processor 1 inputs the plurality of characteristic waveforms into the random forest model, and the random forest model outputs the first on-off state identification timing records, the second on-off state identification timing records, and the third on-off state identification timing records based on the plurality of characteristic waveforms. The first on-off state identification timing records comprise a plurality of on-off state identification results for the electrical appliance B_1 and a plurality of time points corresponding thereto. The second on-off state identification timing records comprise a plurality of on-off state identification results for the electrical appliance B_2 and a plurality of time points corresponding thereto. The third on-off state identification timing records comprise a plurality of on-off state identification results for the electrical appliance B_3 and a plurality of time points corresponding thereto.

The processor 1 inputs the plurality of characteristic waveforms into an extreme gradient boosting model, and the extreme gradient boosting model outputs the fourth on-off state identification timing records, the fifth on-off state identification timing records, and the sixth on-off state identification timing records. The fourth on-off state identification timing records comprise a plurality of on-off state identification results for the electrical appliance B_1 and a plurality of time points corresponding thereto. The fifth on-off state identification timing records comprise a plurality of on-off state identification results for the electrical appliance B_2 and a plurality of time points corresponding thereto. The sixth on-off state identification timing records comprise a plurality of on-off state identification results for the electrical appliance B_3 and a plurality of time points corresponding thereto.

The processor 1 inputs the plurality of characteristic waveforms into an adaptive boosting model, and the adaptive boosting model outputs the seventh on-off state identification timing records, the eighth on-off state identification timing records, and the ninth on-off state identification timing records. The seventh on-off state identification timing records comprise a plurality of on-off state identification results for the electrical appliance B_1 and a plurality of time points corresponding thereto. The eighth on-off state identification timing records comprise a plurality of on-off state identification results for the electrical appliance B_2 and a plurality of time points corresponding thereto. The ninth on-off state identification timing records comprise a plurality of on-off state identification results for the electrical appliance B_3 and a plurality of time points corresponding thereto.

In S207, the processor 1 generates the on-off state timing records for each electrical appliance based on the plurality of on-off state identification timing records outputted by the on-off state identification models.

In S208, the processor 1 generates the corresponding on-off states for each electrical appliance based on the on-off state timing records. Specifically, the processor 1 filters a majority of the plurality of on-off state identification timing records for each electrical appliance as the on-off state timing records by a majority voting method.

Through ensemble learning using the plurality of on-off state identification models, not only does this approach provide high tolerance for complex environments, but it also improves the accuracy of identifying the on-off states of electrical appliances.

For example, when the random forest model, the extreme gradient model, and the adaptive boosting model output more than two on-state results out of three on-off identification results for electrical appliance B_1, the processor 1 determines that the electrical appliance B_1 is in the on-state. Conversely, when more than two of the three on-off identification results from the random forest model, the extreme gradient model, and the adaptive boosting model indicate the off-state for the electrical appliance B_1, the processor 1 determines that the electrical appliance B_1 is in the off-state.

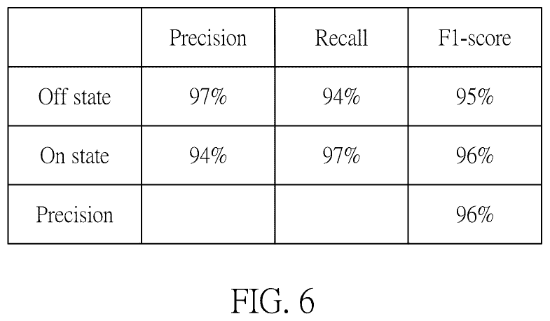

FIG. 6 presents the performance evaluation data table for the electrical appliance monitoring method provided by the present disclosure. The electrical appliance monitoring method of the present disclosure is used to identify the on-off states of electrical appliances, and the performance evaluation is based on three evaluation metrics: Precision, Recall, and F1-score. The F1-score can be expressed by the following formula: F1-score=2*Precision*Recall/(Precision+Recall).

By adopting the electrical appliance monitoring method provided by the present disclosure, the identification of the off state of electrical appliances achieves a precision rate of 97%, a recall rate of 94%, and an F1-score of 95%.

Moreover, through the adoption of the electrical appliance monitoring method provided by the present disclosure, the identification of the on state of electrical appliances achieves a precision rate of 94%, a recall rate of 97%, and an F1-score of 96%.

Based on the overall evaluation data, the electrical appliance monitoring method of the present disclosure achieves an accuracy rate of 96%, which demonstrates the high accuracy in identifying the on-off states of electrical appliances, making it applicable to the field of power monitoring.

### Advantageous Effects of the Embodiments

One of the advantageous effects of the present disclosure is that the electrical appliance monitoring system and the electrical appliance monitoring method provided by the present disclosure, through the use of transfer learning technology, not only enable low sampling rate extraction of feature values for various electrical appliances, but also effectively reduce the error rate in identifying the on-off states of low-power-consuming electrical appliances. By utilizing ensemble learning with a plurality of on-off identification models, the present disclosure achieves a high tolerance for complex environments and improves the accuracy of identifying the on-off states of electrical appliances.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electrical appliance monitoring system, comprising:
a processor; and
a storage circuit, electrically connected to the processor and configured to store a power consumption data model and a plurality of on-off state identification models;
wherein the processor is configured to access the storage circuit to perform the following steps:
executing the power consumption data model to output a plurality of power timing records according to a total power timing data, wherein the plurality of power timing records respectively correspond to a plurality of electrical appliances;
extracting a plurality of characteristic waveforms from the power consumption data model;
executing the plurality of on-off state identification models, wherein each of the on-off state identification models is configured to output a plurality of on-off state identification timing records according to the plurality of characteristic waveforms, and the plurality of on-off state identification timing records respectively correspond to the plurality of electrical appliances;
generating an on-off state timing record for each electrical appliance according to the plurality of on-off state identification models; and
generating a plurality of on-off states corresponding to each electrical appliance according to the on-off state timing records.

2. The electrical appliance monitoring system according to claim 1, wherein each of the on-off state identification timing records comprises a plurality of on-off identification values, and the plurality of on-off states corresponding to each electrical appliance are determined within a predetermined sampling period.

3. The electrical appliance monitoring system according to claim 1, wherein the processor is configured to perform a first pre-training procedure based on a historical total power timing data and a plurality of historical power timing records corresponding to the plurality of electrical appliances to obtain the power consumption data model.

4. The electrical appliance monitoring system according to claim 3, wherein the processor is further configured to convert the plurality of historical power timing records into a plurality of historical on-off labels based on a power consumption threshold, extract a plurality of pre-trained characteristic waveforms from the power consumption data model generated in the first pre-training procedure, and perform a second pre-training procedure based on the plurality of historical on-off labels and the plurality of pre-trained characteristic waveforms to obtain the plurality of on-off state identification models.

5. The electrical appliance monitoring system according to claim 1, wherein the power consumption data model is a convolutional neural network model, and the plurality of on-off state identification models comprise at least one of a random forest model, an extreme gradient model, or an adaptive boosting model.

6. The electrical appliance monitoring system according to claim 1, wherein the power consumption data model is a convolutional neural network model, the convolutional neural network model comprises a fully connected layer, and a number of the plurality of characteristic waveforms corresponds to a number of neurons in the fully connected layer.

7. The electrical appliance monitoring system according to claim 6, wherein extracting the plurality of characteristic waveforms from the power consumption data model further comprises:
removing an output layer of the convolutional neural network model and outputting the plurality of characteristic waveforms through the fully connected layer.

8. The electrical appliance monitoring system according to claim 1, wherein generating the on-off state timing record for each electrical appliance further comprises:
filtering a majority of the plurality of on-off state identification timing records for each electrical appliance as the on-off state timing records by a majority voting method.

9. An electrical appliance monitoring method, comprising:
accessing a storage circuit via a processor to perform the following steps:
executing the power consumption data model to output a plurality of power timing records according to a total power timing data, wherein the plurality of power timing records respectively correspond to a plurality of electrical appliances;
extracting a plurality of characteristic waveforms from the power consumption data model;
executing the plurality of on-off state identification models, wherein each of the on-off state identification models is configured to output a plurality of on-off state identification timing records according to the plurality of characteristic waveforms, and the plurality of on-off state identification timing records respectively correspond to the plurality of electrical appliances;
generating an on-off state timing record for each electrical appliance according to the plurality of on-off state identification models; and
generating a plurality of on-off states corresponding to each electrical appliance according to the on-off state timing records.

10. The electrical appliance monitoring method according to claim 9, wherein each of the on-off state identification timing records comprises a plurality of on-off identification values, and the plurality of on-off states corresponding to each electrical appliance are determined within a predetermined sampling period.

11. The electrical appliance monitoring method according to claim 9, wherein the processor is configured to perform a first pre-training procedure based on a historical total power timing data and a plurality of historical power timing records corresponding to the plurality of electrical appliances to obtain the power consumption data model.

12. The electrical appliance monitoring method according to claim 11, wherein the processor is further configured to convert the plurality of historical power timing records into a plurality of historical on-off labels based on a power consumption threshold, extract a plurality of pre-trained characteristic waveforms from the power consumption data model generated in the first pre-training procedure, and perform a second pre-training procedure based on the plurality of historical on-off labels and the plurality of pre-trained characteristic waveforms to obtain the plurality of on-off state identification models.

13. The electrical appliance monitoring method according to claim 9, wherein the power consumption data model is a convolutional neural network model, and the plurality of on-off state identification models comprise at least one of a random forest model, an extreme gradient model, or an adaptive boosting model.

14. The electrical appliance monitoring method according to claim 9, wherein the power consumption data model is a convolutional neural network model, the convolutional neural network model comprises a fully connected layer, and a number of the plurality of characteristic waveforms corresponds to a number of neurons in the fully connected layer.

15. The electrical appliance monitoring method according to claim 14, wherein extracting the plurality of characteristic waveforms from the power consumption data model further comprises:
removing an output layer of the convolutional neural network model and outputting the plurality of characteristic waveforms through the fully connected layer.

16. The electrical appliance monitoring method according to claim 9, wherein
generating the on-off state timing record for each electrical appliance further comprises:
filtering a majority of the plurality of on-off state identification timing records for each electrical appliance as the on-off state timing records by a majority voting method.
